(19) United States
(12) Patent Application Publication
(10) Pub. No.: US 2025/0258289 A1
(43) Pub. Date: Aug. 14, 2025

(54) SYSTEM AND METHOD FOR DETECTING AN OJECT IN A SCANNER

(71) Applicant: Leidos Security Detection & Automation, Inc., Tewksbury, MA (US)

(72) Inventor: Nicholas E. Ortyl, III, Bedford, MA (US)

(21) Appl. No.: 18/439,520

(22) Filed: Feb. 12, 2024

(51) Int. Cl. G01S 13/88; G01S 7/02; G01S 7/282; G01S 13/04; G01S 13/56; G01S 13/90; G01V 5/226

(52) U.S. Cl. CPC G01S 13/887; G01S 7/027; G01S 7/282; G01S 13/04; G01S 13/56; G01S 13/9029; G01V 5/226

(57) ABSTRACT

Systems and methods provide for detecting an object in a body scanner system. The body scanner system includes a first imaging mast, a second imaging mast, and a processing system. The processing system includes a memory having computer readable instructions and a processing device for executing the computer readable instructions. The computer readable instructions control the processing device to perform operations. The operations include transmitting and receiving electromagnetic waves by the first imaging mast or the second imaging mast while stationary. The operations further include detecting an object entering the body scanner system based on the electromagnetic waves received by the first imaging mast or the second imaging mast. The operations further include, responsive to detecting the object entering the body scanner system, implementing a corrective action.

### BACKGROUND

Non-contact screening is an important tool to detect the presence of contraband or hazardous items being carried by an individual entering a restricted area or transportation hub such as a secure building, an airport, or a train station. Various technologies have been used for non-contact screening including x-ray and millimeter-wave imaging. Such technologies can be used to produce images that reveal hidden objects carried on a person that are not visible to plain sight.

### SUMMARY

According to an embodiment, a body scanner system is provided. The body scanner system includes a first imaging mast, a second imaging mast, and a processing system. The processing system includes a memory having computer readable instructions and a processing device for executing the computer readable instructions. The computer readable instructions control the processing device to perform operations. The operations include transmitting and receiving electromagnetic waves by the first imaging mast or the second imaging mast while stationary. The operations further include detecting an object entering the body scanner system based on the electromagnetic waves received by the first imaging mast or the second imaging mast. The operations further include, responsive to detecting the object entering the body scanner system, implementing a corrective action.

According to an embodiment, a computer-implemented method for detecting an object entering or egressing a body scanner system is provided. The method includes transmitting and receiving electromagnetic waves by a first imaging mast or a second imaging mast of the body scanner system while stationary. The method further includes detecting the object entering or egressing the body scanner system based on the electromagnetic waves received by the first imaging mast or the second imaging mast. The method further includes, responsive to detecting the object entering or egressing the body scanner system, implementing a corrective action.

### BRIEF DESCRIPTION OF DRAWINGS

Illustrative embodiments are shown by way of example in the accompanying drawings and should not be considered as a limitation of the present disclosure.

FIG. 1A illustrates a self-serve screening environment according to one or more embodiments described herein;

FIG. 1B schematically illustrates a top view of a system for screening of individuals to detect hidden objects.

FIG. 2A schematically illustrates a computing device for use with some embodiments described herein.

FIG. 2B schematically illustrates a network environment for use with the systems and methods of some embodiments described herein.

FIG. 3 illustrates a scanner having light curtain devices that provide traffic flow functionality according to one or more embodiments described herein.

FIG. 4 illustrates a flow diagram of a method for detecting objects in a scanner according to one or more embodiments described herein.

### DETAILED DESCRIPTION

Described in detail herein are systems and methods for motion detection using millimeter waves. Particularly, one or more embodiments described herein provide for detecting motion of an object in a millimeter wave scanner.

Non-contact screening devices (also referred to simply as “scanners”), such as a body scanner, can be used to scan an object (e.g., an item or an individual) for contraband, hazardous materials, and/or the like including combinations and/or multiples thereof. For example, in an airport environment, a body scanner can be used to scan passengers (e.g., individuals) before the passengers are permitted access to a restricted area. As another example, in a data center environment or other restricted access environment, a body scanner can be used to scan technicians (e.g., individuals) before the technicians are permitted access to the data center (i.e., restricted access environment). In these cases and others, it may be desirable to detect the presence of an object (e.g., an item or individual) entering, leaving or within the body scanner.

It is often desirable to detect the presence of objects in such screening devices. For example, if two individuals enter a body scanner together, it is desirable to detect this situation and alert an operator, such as a transportation security officer (TSO). As another example, an individual may attempt to pass an object, for example a contraband object, through the screening device, such as by throwing the object through the screening device. For example, a first individual could be screened by a body scanner, and the first individual could then pass into a restricted area. A second individual could then throw a contraband object through the screening device to the first individual in the restricted area. The second individual could then be screened by the body scanner and then pass into the restricted area. In such cases, the two individuals are screened and “cleared” by the scanner, yet the screening process is circumvented in that the contraband object enters the restricted area without detection.

Accordingly, one or more embodiments described herein provide for detecting an object entering, leaving or in a screening device, such as a body scanner. For example, imaging masts of a body scanner or one or more RF transmitter/receiver arrays (also referred to as linear transceiver arrays) separate from the imaging masts or both can be used to detect when an object enters the scanner. An object can be an individual or any other item, such as a USB flash drive, a bag, a weapon, and/or the like including combinations and/or multiples thereof. As an example, the Doppler effect of the electromagnetic waves emitted by imaging masts of a body scanner can be used to detect objects. For example, as described herein and as shown in the figures, a body scanner can include imaging masts that emit electromagnetic radiation, such as at a regular rate (e.g., 256 pulses per second). Based on a received signal a computing device can analyze the strength of a returned pulse, the time it took to travel to the object and back, and the phase or Doppler shift of the pulse and determine if an object has entered the body scanner. The Doppler effect of the electromagnetic radiation can be used to detect when an object enters, exits or is within the scanner, such as an object moving through the scanner. The entrance of the object into the body scanner may be expected or not. For example, in a case where there is a queue of individuals to be scanned the body scanner can determine when one of the individuals has entered the body scanner and initiate a body scanning process. As another example, in a case where an individual is waiting to enter the body scanner, but is in possession of an object that they do want to enter the body scanner with, the individual may attempt to throw the object through the scanner to try and avoid detection of the object. In such a case, a body scanner as taught herein is able to detect the object entered the scanner and take an action to alert, for example, security personnel. According to one or more embodiments described herein, linear transceiver array system separate from the imaging masts of the body scanner is used to detect the presence of an object in a scanner. For example, the linear transceiver array system can used as a synthetic-aperture radar (SAR) to detect the presence of an object in a scanner.

Systems and methods of the present disclosure improve the effectiveness of scanners, such as body scanners, by using the imaging masts of the scanners to at least detect when an object enters the body scanner. For example, by using the existing imaging masts and the associated electromagnetic radiation, the imaging masts can be further purposed to detect when an object that enters or leaves the body scanner.

Further, systems and methods of the present disclosure improve the user experience by using light curtains to control the flow of individuals into and out of scanners. Light curtains are less intrusive to individuals than physical barriers and thus improve the user experience. Further, the light curtains can be used to detect objects that are not authorized (e.g., an object entering a scanner when a scan of another object (e.g., individual) is being performed). This improves the accuracy and reliability of scanner by detecting unauthorized objects. According to one or more embodiments described herein, the imaging masts and the light curtains can be used in conjunction to improve redundancy and/or accuracy for object detection.

One or more of the embodiments described herein can be implemented in airport environments and/or non-airport environments. An operator that aids in the scanning operations described herein can be a security officer, such as a transportation security officer (TSO), or can be other than a security officer.

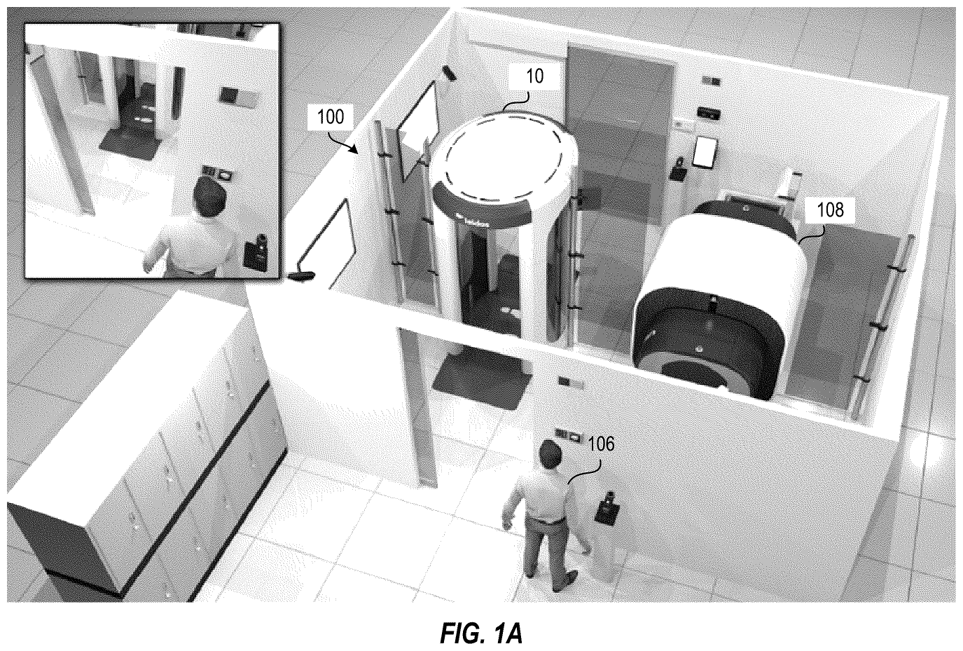

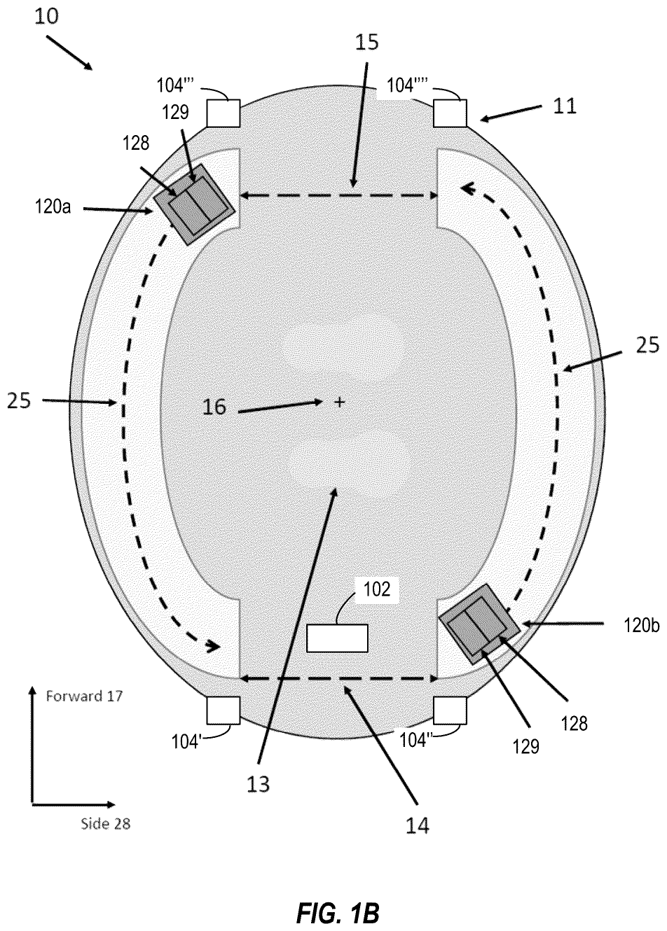

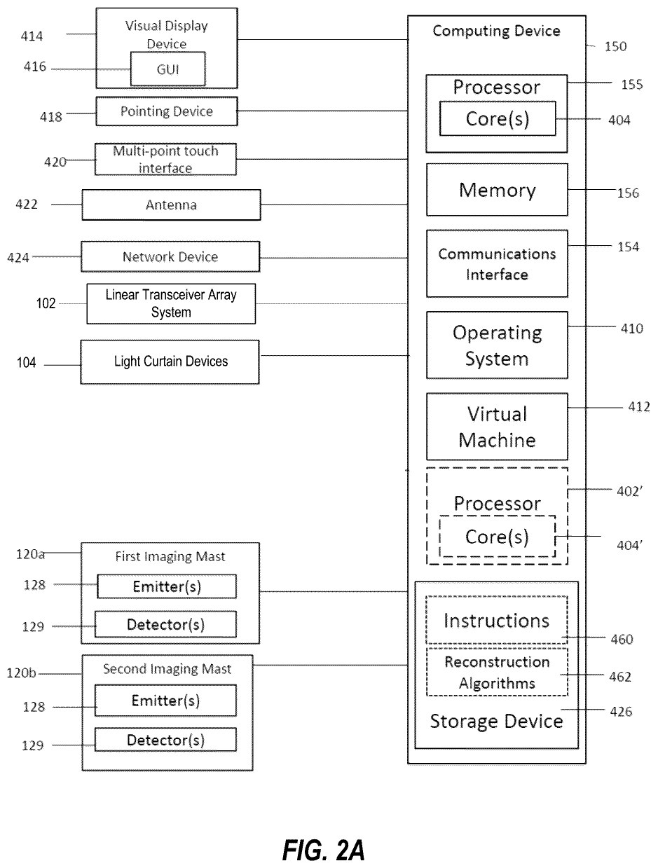

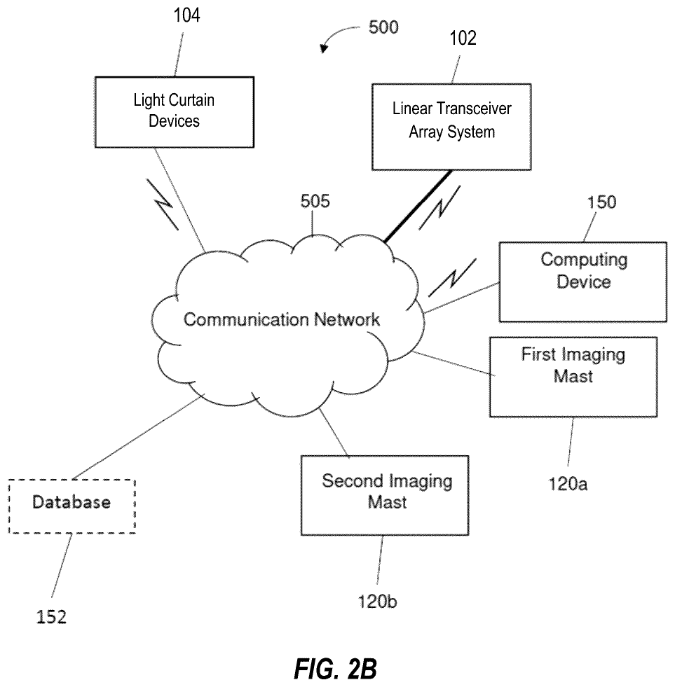

FIG. 1A illustrates a self-serve screening environment 100 according to one or more embodiments described herein. The self-serve screening environment 100 includes a body scanner 10 for imaging an object (e.g., an item or an individual) according to one or more embodiments described herein. The body scanner 10 shown in FIGS. 1A and 1B provides scanning capabilities as described herein. According to one or more embodiments described herein, the body scanner 10 uses a millimeter wave scanning system (or “mmwave imager”). The self-serve screening environment 100 can also include other components, such as an x-ray scanner 108 for scanning items (e.g., bags, luggage, etc.), access control devices (e.g., doors, panels, etc.), access authentication devices (e.g., card readers, biometric readers, etc.), and/or the like including combinations and/or multiples thereof. The body scanner 10 can include multiple components, as described herein (see, e.g., FIGS. 1B and 2A), including imaging masts 120a, 120b and light curtain devices 104. The imaging masts 120a, 120b can be used to detect an object (e.g., an individual; an item, such as a USB flash drive; and/or the like including combinations and/or multiples thereof) entering or egressing the body scanner 10. For example, the imaging masts 120a, 120b, while in a fixed position (i.e., not moving) can be used to detect the entrance or egress of an object, such as individual or item, into or out of the body scanner 10.

According to one or more other embodiments described herein, a linear transceiver array system 102 separate from the imaging masts 120a, 120b can be associated with the body scanner 10 and used to detect objects by emitting and detecting signals and using the Doppler effect associated with those signals to detect the objects. In such an embodiment, the linear transceiver array system 102 could be located at or near an entrance and/or exit of the body scanner and configured to transmit in a vertical direction (e.g., upwardly or downwardly) to detect ingress or egress of an object into the body scanner 10. According to one or more embodiments, one or more cameras (not shown) can be used in conjunction with or instead of the linear transceiver array system 102 to perform an image-based analysis for detecting objects entering or exiting the body scanner 10. For example, the cameras can be co-located with the linear transceiver array system 102 and/or used in place of the linear transceiver array system 102. In such embodiments, the one or more cameras can capture images and/or video, which can be analyzed using a time of flight analysis technique to detect objects entering or exiting the body scanner 10. In one or more embodiments, aspects of the linear transceiver array system 102 and aspects of the image-based analysis can be merged for detecting objects entering or exiting the body scanner 10. For example, one of the linear transceiver array system 102 or the image-based analysis can detect an object entering or exiting the body scanner 10 and the other of the linear transceiver array system 102 or the image-based analysis can verify that the detection was accurate (i.e., dual independent detection).

According to one or more embodiments described herein, the light curtain devices 104 can be used to signal when an individual should enter and/or exit the body scanner 10. For example, the light curtain devices 104 using visible light can generate a visible light curtain that indicates to an individual not to pass through an opening (e.g., an entrance or exit of the body scanner 10) when enabled. According to one or more embodiments described herein, the light curtain devices 104 can be used to detect an object, such as an individual or item, entering or exiting the body scanner 10. For example, if an object passes through a light curtain, the light curtain is interrupted, signaling that an object passed through the light curtain.

FIG. 1B illustrates a top-view of the body scanner 10 for imaging an object according to one or more embodiments described herein. In some embodiments, the body scanner 10 can have multiple modes. One mode, for example a sentry mode, can be used to detect the entrance or exit of an object from the body scanner 10. One mode, for example a scan mode, can be used to scan an object once it enters the body scanner 10. One mode, for example a combined sentry and scan mode, can be used to detect the entrance of an object into the body scanner 10 and then scan the object to detect contraband.

An example of the body scanner 10 in a mode to scan an object once it enters the body scanner 10 is described below. The object enters the imaging chamber 11 in a forward direction 17 through the entrance 14 and stands at or about a central point 16 in the chamber. Consider the following example for the object being an individual. The central point 16 can be indicated using instructional markings 13 to aid the individual in understanding how to stand for purposes of scanning such as footprint markings. The individual turns in a direction orthogonal to an axis that connects the entrance 14 and an exit 15 of the chamber 11. In other words, the individual turns 90°, often to the right, to face a side direction 28. Once the individual is in a correct location within the imaging camber 11, the individual assumes a scanning position, which is referred to as a pose. An example of a pose is as follows: The individual places his or her hands over his or her head. Other poses are also possible, such as the individual standing naturally in a relaxed stance with his or her arms at his or her side or with hands placed on hips. Once the individual is in the scanning position (e.g., has assumed the pose), two imaging masts 120a, 120b rotate around the individual on scan paths 25 as indicated by the arrows in FIG. 1.

According to one or more embodiments, the user can be instructed on how to achieve a target pose for purposes of scanning, such as described in U.S. patent application Ser. No. 18/460,250, the contents of which are incorporated by reference herein in their entirety. For example, an optical imaging device (e.g., a camera) can capture an image of a user and use the image to determine a pose of the user. The pose of the user can then be compared to a target pose to determine whether the user is positioned correctly. The target pose is a predefined pose for the user to be scanned. The user can be provided with real-time (or near-real-time) instructions to support the user achieving the target pose. For example, a display associated with a body scanner can visually illustrate the target pose and the pose of the user. The user can then adjust to achieve the target pose. When the user achieves the target pose, a scan of the user may be performed, such as by the body scanner 10 (e.g., a millimeter wave scanning system).

The imaging masts 120a, 120b are connected in a “tuning fork” shaped configuration to a rigid central mount located in a roof of the chamber 11. Because the two imaging masts 120a, 120b are rigidly connected, they both rotate in a same direction, e.g., clockwise or counter-clockwise, and maintain a constant spacing distance between them. The imaging masts 120a, 120b include both transmitters 128 (also referred to as “emitters”) and receivers 129 (also referred to as “detectors”). Each receiver 129 is spatially associated with a transmitter 128 such as by being placed in close proximity so as to form or act as a single point transmitter/receiver. In operation, the transmitters 18 sequentially transmit electromagnetic radiation one at a time that is reflected or scattered from the object, and the reflected or scattered electromagnetic radiation is received by two of the respective receivers 19.

In the scan mode, the imaging masts 120a, 120b move in unison. While the imaging masts 120a, 120b move, the transmitters 128 sequentially transmit electromagnetic radiation one at a time that is reflected or scattered from the object, and the reflected or scattered electromagnetic radiation is received by two of the respective receivers 129. According to one or more embodiments described herein, one or both imaging masts transmit and receive. In some embodiments, a first imaging mast (e.g., the imaging mast 120a) detects the object and a second imaging mast (e.g., the imaging mast 120b) is used to verify the detection by the first imaging mast. In the sentry mode, the imaging masts 120a, 120b are stationary, but pulsing to detect entrance of an object. According to one or more embodiments, in the sentry mode, one of the imaging masts 120a, 120b is operational (e.g., pulsing) while the other imaging mast is deactivated (e.g., not pulsing). More particularly, the transmitters 128 transmit the electromagnetic radiation on a periodic basis (e.g., at a pulse rate). For example, the detection is based at least in part on a pulse rate of the electromagnetic radiation emitted by at least one of the first imaging mast 120a and the second imaging mast 120b. As a non-limiting example, the electromagnetic radiation is pulsed at a rate of 256 pulses per second. That is, every 1/256 of a second, an electromagnetic radiation pulse is emitted by one or both of the imaging masts 120a, 120b, and the imaging masts 120a, 120b detect the return signal from the pulse of electromagnetic radiation. Based on the return signal detected by the imaging masts 120a, 120b (in either the scanning mode or the sentry mode), the computing device 150 can determine whether an object (e.g., a USB flash drive being thrown through the body scanner 10) is present. According to one or more embodiments described herein, the computing device 150 uses the Doppler effect of the electromagnetic radiation to detect the object. A computing device receives signals from the receivers 129 and reconstructs an image of the object using a monostatic reconstruction technique. Hidden objects or contraband may be visible on the image because the density or other material properties of the hidden object differ from organic tissue and create different scattering or reflection properties that are visible as contrasting features or areas on an image.

In the combined sentry and scan mode, the imaging masts 120a, 120b are transmitting and receiving while they are stationary, when it is determined that an object has entered the body scanner via processing of any Doppler effect, the imaging mases 120a, 120b can begin moving to scan the object.

It should be appreciated that the body scanner 10 is one of many different possible systems for scanning objects (e.g., individuals). The one or more embodiments described herein that provide for determining that a pose of the object satisfies a target pose can be used with any suitable style or configuration of scanner. For example, a walkthrough style scanner can be used, as taught in U.S. patent application Ser. No. 18/126,795, the contents of which are incorporated by reference herein in their entirety.

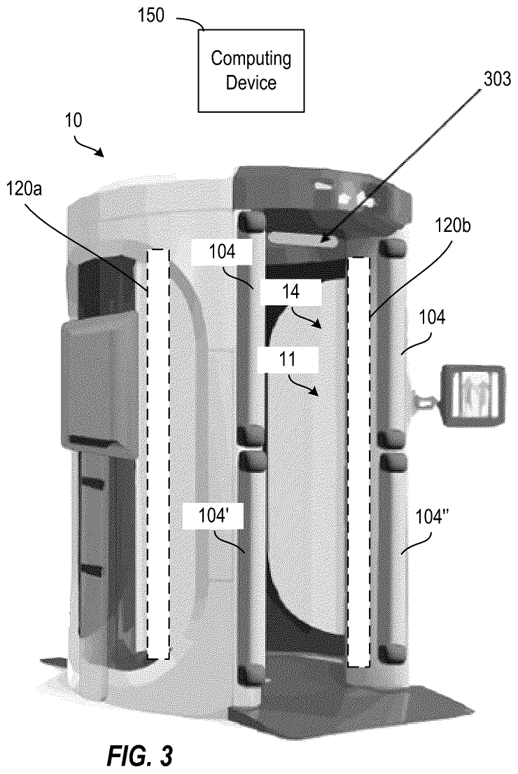

According to one or more embodiments described herein, the body scanner 10 also includes light curtain devices 104. In this example, a pair of light curtain devices 104 are associated with each of the entrance 14 and the exit 15. Specifically, two light curtain devices 104′, 104″ are associated with the entrance 14 of the chamber 11 of the body scanner 10, and two light curtain devices 104′″, 104″″ are associated with the exit 15 of the chamber 11 of the body scanner 10. Each pair of light curtain devices can include a transmitter light curtain device and a receiver light curtain device. For example, the light curtain devices 104′ and 104″′ can be transmitter light curtain devices, and the light curtain devices 104″ and 104″″ can be receiver light curtain devices. The light curtain devices 104 are further described herein with reference to FIG. 3, for example.

FIG. 2A is a block diagram of a computing device 150 suitable for use with embodiments of the present disclosure. The computing device 150 may be, but is not limited to, a smartphone, laptop, tablet, desktop computer, server, or network appliance. The computing device 150 includes one or more non-transitory computer-readable media for storing one or more computer-executable instructions or software for implementing the various embodiments taught herein. The non-transitory computer-readable media may include, but are not limited to, one or more types of hardware memory (e.g., memory 156), non-transitory tangible media (for example, storage device 426, one or more magnetic storage disks, one or more optical disks, one or more flash drives, one or more solid state disks), and the like. For example, memory 156 included in the computing device 150 may store computer-readable and computer-executable instructions 460 or software (e.g., instructions to receive data from receivers 129 (also referred to as “detectors”) of the imaging masts 120, instructions to receive data from a linear transceiver array system 102, instructions to selectively enable/disable light curtain devices 104, instructions to perform image reconstruction methods using monostatic or multistatic reconstruction algorithms 462; etc.) for implementing operations of the computing device 150. The computing device 150 also includes configurable and/or programmable processor 155 and associated core(s) 404, and optionally, one or more additional configurable and/or programmable processor(s) 402′ and associated core(s) 404′ (for example, in the case of computer systems having multiple processors/cores), for executing computer-readable and computer-executable instructions or software stored in the memory 156 and other programs for implementing embodiments of the present disclosure. Processor 155 and processor(s) 402′ may each be a single core processor or multiple core (404 and 404′) processor. Either or both of processor 155 and processor(s) 402′ may be configured to execute one or more of the instructions described in connection with computing device 150.

Virtualization may be employed in the computing device 150 so that infrastructure and resources in the computing device 150 may be shared dynamically. A virtual machine 412 may be provided to handle a process running on multiple processors so that the process appears to be using only one computing resource rather than multiple computing resources. Multiple virtual machines may also be used with one processor.

Memory 156 may include a computer system memory or random access memory, such as DRAM, SRAM, EDO RAM, and the like. Memory 156 may include other types of memory as well, or combinations thereof.

A user may interact with the computing device 150 through a visual display device 414 (e.g., a computer monitor, a projector, and/or the like including combinations and/or multiples thereof), which may display one or more graphical user interfaces 416. The user may interact with the computing device 150 using a multi-point touch interface 420 or a pointing device 418.

The computing device 150 may also include one or more computer storage devices 426, such as a hard-drive, CD-ROM, or other computer readable media, for storing data and computer-readable instructions 460 and/or software that implement exemplary embodiments of the present disclosure (e.g., applications). For example, exemplary storage device 426 can include instructions 460 or software routines to enable data exchange with one or more imaging masts 120a, 120b, the light curtain devices 104, or the linear transceiver array system 102. The storage device 426 can also include reconstruction algorithms 462 that can be applied to imaging data and/or other data to reconstruct images of scanned objects, such as using data from the first imaging mast 120a, the second imaging mast 120b, and/or the linear transceiver array system 102, including combinations thereof.

The computing device 150 can include a communications interface 154 configured to interface via one or more network devices 424 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing device 150 can include one or more antennas 422 to facilitate wireless communication (e.g., via the network interface) between the computing device 150 and a network and/or between the computing device 150 and components of the system such as imaging masts 120a, 120b, the linear transceiver array system 102, and/or the light curtain devices 104. The communications interface 154 may include a built-in network adapter, network interface card, PCMCIA network card, card bus network adapter, wireless network adapter, USB network adapter, modem or any other device suitable for interfacing the computing device 150 to any type of network capable of communication and performing the operations described herein.

The computing device 150 may run an operating system 410, such as versions of the Microsoft® Windows® operating systems, different releases of the Unix® and Linux® operating systems, versions of the MacOS® for Macintosh computers, embedded operating systems, real-time operating systems, open source operating systems, proprietary operating systems, or other operating system capable of running on the computing device 150 and performing the operations described herein. In exemplary embodiments, the operating system 410 may be run in native mode or emulated mode. In an exemplary embodiment, the operating system 410 may be run on one or more cloud machine instances.

FIG. 2B illustrates a network environment 500 including the computing device 150 and other elements of the systems described herein that is suitable for use with exemplary embodiments. The network environment 500 can include one or more databases 152, one or more imaging masts 120, 120a, 120b, one or more linear transceiver array systems 102, one or more light curtain devices 104, and one or more computing devices 150 that can communicate with one another via a communications network 505. As described herein, one or more cameras (not shown) can be used instead of or in conjunction with the one or more linear transceiver array systems 102 to perform an image-based analysis technique for detecting objects entering or exiting the body scanner 10. For example, the cameras can be co-located with the linear transceiver array system 102 and/or used in place of the linear transceiver array system 102. In such embodiments, the one or more cameras can capture images and/or video, which can be analyzed using a time of flight analysis technique to detect objects entering or exiting the body scanner 10. In one or more embodiments, aspects of the linear transceiver array system 102 and aspects of the image-based analysis can be merged for detecting objects entering or exiting the body scanner 10. For example, one of the linear transceiver array system 102 or the image-based analysis can detect an object entering or exiting the body scanner 10 and the other of the linear transceiver array system 102 or the image-based analysis can verify that the detection was accurate (i.e., dual independent detection).

The computing device 150 can host one or more applications (e.g., instructions 460 or software to communicate with or control imaging masts 120, transmitters 128, receivers 129, linear transceiver array system 102, light curtain devices 104, and any/or mechanical, motive, or electronic systems associated with these system aspects; reconstruction algorithms 462; or graphical user interfaces 416) configured to interact with one or more components of the body scanner 10 to facilitate access to the content of the databases 152. The databases 152 may store information or data including instructions 460 or software, reconstruction algorithms 462, or imaging data as described above. Information from the databases 152 can be retrieved by the computing device 150 through the communications network 505 during an imaging or scanning operation. The databases 152 can be located at one or more geographically distributed locations away from some or all system components (e.g., imaging masts 120, linear transceiver array system 102, light curtain devices 104) and/or the computing device 150. Alternatively, the databases 152 can be located at the same geographical location as the computing device 150 and/or at the same geographical location as the system components. The computing device 150 can be geographically distant from the chamber 111 or other system components (imaging masts 120a, 120b, linear transceiver system 102, light curtain devices 104, etc.). For example, the computing device 150 and operator can be located in a secured room sequestered from the location where the scanning of objects takes place to alleviate privacy concerns. The computing device 150 can also be located entirely off-site in a remote facility.

In an example embodiment, one or more portions of the communications network 505 can be an ad hoc network, a mesh network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a Wi-Fi network, a WiMAX network, an Internet-of-Things (IoT) network established using BlueTooth® or any other protocol, any other type of network, or a combination of two or more such networks.

Turning now to FIG. 3, the computing device 150 can provide object detection and/or traffic flow direction. According to one or more embodiments described herein, the body scanner 10 can be configured with object detection capabilities to detect motion within the body scanner 10 (e.g., to detect objects) using Doppler techniques. For example, the body scanner 10 can include the imaging masts 120a, 120b as described herein, which can be used to detect objects entering, within, or exiting the body scanner 10. More particularly, the imaging masts 120a, 120b of the body scanner 10 can be used to detect motion into, out off and within the body scanner 10. For example, the imaging masts 120a, 120b emit electromagnetic radiation, and the computing device 150 can use the Doppler effect of the electromagnetic radiation to detect objects, entering, egressing or in the body scanner 10. The imaging masts 120a, 120b can be used to actively collect data that generates energy (e.g., electromagnetic radiation) and then records the amount of return energy reflected back after interacting with an object. Using that data, the computing device 150 can create two-dimensional and/or three-dimensional representations of objects (e.g., the individual 106, an item (e.g., baggage, a USB flash drive), and/or the like including combinations and/or multiples thereof).

In some embodiments, for example, a sentry mode, the imaging masts 120a, 120b can be stationary, enabled and chirped at a pulse rate that enables detection of an object (e.g., the individual 106, an item (e.g., a USB flash drive)) entering through the entrance 14, moving within the chamber 10, and/or exiting through the exit 15. For example, the imaging masts 120a, 120b can use a pulse rate that is substantially 256 pulses of electromagnetic radiation per second, although other pulse rates can be used in other embodiments.

According to one or more embodiments described herein, the body scanner 10 can detect objects and/or direct the flow of traffic using a light curtain(s), such as to detect and/or control movement of an object (e.g., the individual 106) into and out of a scanner (e.g., the body scanner 10). For example, FIG. 3 show the body scanner 10 using light curtains. Particularly, the body scanner 10 is configured with multiple light curtain devices 104. The light curtain devices 104 generate a light curtain that can detect when an object (e.g., the individual 106) passes through the light curtain (e.g., when the individual 106 passes through an opening (e.g., the entrance 14)) of the body scanner 10). In the example of FIG. 3, two pairs of light curtain devices 104 are associated with the entrance 14 of the body scanner 10. Each of the pairs of light curtain devices 104 includes a transmitter light curtain device and a receiver light curtain device. For example, the light curtain device 104′ can be a transmitter light curtain device, and the light curtain device 104″ can be a receiver light curtain device.

According to one or more embodiments described herein, the light curtain devices 104 can function as a virtual barrier to restrict entry into or exit out of a certain area, such as the body scanner 10. For example, the light curtain devices 104′, 104″ in FIG. 3 are positioned on each side of the entrance 14 of the body scanner 10 as shown, although other arrangements are also possible. According to one or more embodiments described herein, the light curtain devices 104 act to restrict entry into or exit out of the body scanner 10 through the entrance 14. For example, the light curtain devices 104 can provide a visible curtain of light that the individual 106 can see, which can alert the individual 106 not to pass through the light curtain. As another example, the light curtain devices 104 act to alert an operator (e.g., a security officer) when the object (e.g., the individual 106) passes through the light curtain. For example, if an object (e.g., the individual 106) passes through the opening 14 when the light curtain devices 104 are engaged (e.g., are generating a light curtain), the light curtain is disrupted, and the light curtain devices 104 can transmit a signal to the computing device 150 indicative of the disruption. The computing device 150 can then generate an alarm, send an alert, and/or take another corrective action, such as closing a physical gate.

According to one or more embodiments described herein, the light curtain devices 104 are opto-electronic devices that form an optical pseudo barrier, when activated, by generating beams of light (e.g., infrared light) from a transmitter light curtain 104′ to a receiver transmitter light curtain 104″. If an object (e.g., the individual 106, an item) passes through the area between the transmitter light curtain 104′ and the receiver transmitter light curtain 104″ when the light curtain devices 104 are activated, the beams of light are interrupted and a signal—such as an audible alarm, message, light color change, or monitor graphic—can be generated to alert to the interruption. The light curtain devices 104 are less imposing on individuals than physical gates because the light curtains may be visible, but not physical barriers (e.g., pseudo barriers). The light curtain devices 104 can be used in conjunction with performing a scan to 1) control the flow individuals entering and/or exiting the body scanner 10, and 2) to detect objects passing through the entrance 14, passing through the chamber 11, and/or passing through the exit 15. For example, if an object (e.g., a USB flash drive) is thrown from one side of the body scanner 10, through the chamber 11, to the other side of the scanner, the object disrupts one or more of the light curtains generated by the light curtain devices 104, and the computing device 150 can implement a suitable corrective action upon detecting the object.

According to one or more embodiments described herein the body scanner 10 includes an entrance guide light 303 that can provide a visual indication to the individual 106. For example, the entrance guide light 303 may be turned on or may be changed to a particular color, such as green, when the individual 106 is permitted to enter the chamber 11. Conversely, the entrance guide light 303 may be turned off or may be changed to a particular color, such as red, when the individual 106 is not permitted to enter the chamber 11. According to one or more embodiments described herein, the body scanner 10 can include an exit guide light (not shown) similar to the entrance guide light. It should be appreciated that the entrance guide light 303 and/or the exit guide light can be incorporated into the body scanner 10 and/or can be stand-alone lights. Further, the lights can use different indicia (e.g., colors, symbols, etc.) to provide information. According to one or more embodiments described herein, a speaker or other sound generating device can be used to supplement the information provided by the lights. For example, a sound may be generated when one or more of the entrance guide light 303 or the exit guide light is illuminated.

According to one or more embodiments described herein, the object detection capabilities of the imaging masts 120a, 120b can be paired with the light curtain devices 104 for redundancy and/or improved accuracy. For example, if a pair of light curtain devices 104 detect a disruption, the imaging masts 120a, 120b can be used to verify whether the detected disruption is an object (e.g., being thrown through the entrance 14) or a false alarm (e.g., the individual 106 accidently disrupts the light curtain when the individual 106 is posing to be scanned. Similarly, if the imaging masts 120a, 120b detect an object, the light curtain devices 104 can be used to verify the presence (or not) of the object.

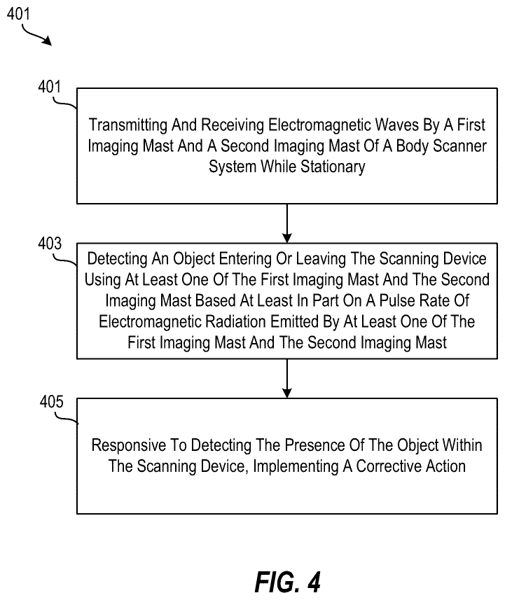

FIG. 4 illustrates a flow diagram of a method 401 for detecting objects entering or egressing a scanner (e.g., the body scanner 10) according to one or more embodiments described herein. The method 401 can be performed by any suitable system or device as described herein, such as the processor 155, the computing device 150, the network environment 500, and/or the like including combinations and/or multiples thereof.

At block 401, the imaging mast 120a and/or the imaging mast 120b transmits and receives electromagnetic waves (e.g., electromagnetic radiation) while the imaging masts 120a, 120b are stationary.

At block 403, the computing device 150 detects an object entering or leaving or both, the scanning device (e.g., the body scanner 10) using at least one of the first imaging mast 120a or the second imaging mast 120b. According to one or more embodiments described herein, the body scanner 10 can be operating in one of two or more different modes: a scan mode, a sentry mode, or a combined scan and sentry mode. In the scan mode, the imaging masts 120a, 120b move in unison. While the imaging masts 120a, 120b move, the transmitters 128 sequentially transmit electromagnetic radiation one at a time that is reflected or scattered from the object, and the reflected or scattered electromagnetic radiation is received by two of the respective receivers 129. In the sentry mode, the imaging masts 120a, 120b are stationary, but pulsing to detect entrance or egress of an object. More particularly, the transmitters 128 transmit the electromagnetic radiation on a periodic basis (e.g., at a pulse rate). For example, the detection is based at least in part on a pulse rate of the electromagnetic radiation emitted by at least one of the first imaging mast 120a and the second imaging mast 120b. As a non-limiting example, the electromagnetic radiation is pulsed at a rate of 256 pulses per second. That is, every 1/256 of a second, an electromagnetic radiation pulse is emitted by one or both of the imaging masts 120a, 120b, and the imaging masts 120a, 120b detect the return signal from the pulse of electromagnetic radiation. Based on the return signal detected by the imaging masts 120a, 120b (in either the scanning mode or the sentry mode), the computing device 150 can determine whether an object (e.g., a USB flash drive being thrown through the body scanner 10) is present. According to one or more embodiments described herein, the computing device 150 uses the Doppler effect of the electromagnetic radiation to detect the object. In a combined scan and sentry mode, the imaging masts 120a, 120b are stationary, but pulsing to detect entrance of an object. After detecting entrance of the object, the imaging masts 120a, 120b move in unison. While the imaging masts 120a, 120b move, the transmitters 128 sequentially transmit electromagnetic radiation one at a time that is reflected or scattered from the object, and the reflected or scattered electromagnetic radiation is received by two of the respective receivers 129.

At block 405, responsive to detecting entrance of the object within the body scanner 10, a corrective action is implemented. For example, an electronic gate can be closed, an auditory and/or visual alarm can be generated, a message can be sent, such as to a security officer, and/or the like including combinations and/or multiples thereof.

This prevents an individual from throwing or otherwise causing an object to pass through the chamber 11 of the body scanner 10 without being detected. For example, as described herein an individual may attempt to pass an object, for example, a contraband object, through the body scanner 10, such as by throwing the object through the body scanner 10. For example, a first individual could be screened by the body scanner 10, and the first individual could then pass into a restricted area. A second individual could then throw an object (e.g., a USB flash drive) through the entrance 14, the chamber 11, and the exit 15 of the body scanner 10 to the first individual in the restricted area. The second individual could then be screened by the body scanner 10 and then pass into the restricted area. In such cases, the two individuals are screened and “cleared” by the body scanner 10, yet the screening process is circumvented in that the contraband object enters the restricted area without detection. This scenario can be avoided by use of the imaging masts 120a, 120b, or the linear transceiver array system 102, or the light curtains 104, or any combination thereof to detect objects. For example, if an object is thrown through the body scanner 10 as described, the object would be detected within the chamber 11 by the imaging masts 120a, 120b (and/or the linear transceiver array system 102). Similarly, if an object is thrown through the body scanner 10 as described, the object would disrupt the light curtain(s) at the entrance 14 and/or the exit 15 and thereby be detected.

Additional processes also may be included, and it should be understood that the processes depicted in FIG. 4 represent illustrations, and that other processes may be added or existing processes may be removed, modified, or rearranged without departing from the scope and spirit of the present disclosure. It should also be understood that the processes depicted in FIG. 4 may be implemented as programmatic instructions stored on a non-transitory computer-readable storage medium that, when executed by a processor (e.g., the processor 155) of a computing system (e.g., the computing device 150), cause the processor to perform the processes described herein.

In describing example embodiments, specific terminology is used for the sake of clarity. Additionally, in some instances where a particular example embodiment includes multiple system elements, device components or method steps, those elements, components or steps may be replaced with a single element, component, or step. Likewise, a single element, component, or step may be replaced with multiple elements, components, or steps that serve the same purpose. Moreover, while example embodiments have been illustrated and described with references to particular embodiments thereof, those of ordinary skill in the art will understand that various substitutions and alterations in form and detail may be made therein without departing from the scope of the present disclosure. Further still, other aspects, functions, and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A body scanner system, the body scanner system comprising:
a first imaging mast and a second imaging mast; and
a processing system comprising:
a memory comprising computer readable instructions; and
a processing device for executing the computer readable instructions, the computer readable instructions controlling the processing device to perform operations comprising:
transmitting and receiving electromagnetic waves by the first imaging mast or the second imaging mast while stationary;
detecting an object entering the body scanner system based on the electromagnetic waves received by the first imaging mast or the second imaging mast; and
responsive to detecting the object entering the body scanner system, implementing a corrective action.

2. The system of claim 1, the operations further comprising determining a direction of movement of the object relative to the first imaging mast or the second imaging mast.

3. The system of claim 1, wherein the detecting is performed using a Doppler effect of the electromagnetic waves emitted by the at least one of the first imaging mast and the second imaging mast.

4. The system of claim 1, wherein the pulse rate is substantially 256 pulses of electromagnetic waves per second.

5. The system of claim 1, wherein the detecting the object is performed using both of the first imaging mast and the second imaging mast based at least in part on a pulse rate of the electromagnetic waves emitted by both of the first imaging mast and the second imaging mast.

6. The system of claim 1, wherein the detecting comprises detecting entrance of the object into the body scanner using the first imaging mast based at least in part on the pulse rate of the electromagnetic waves emitted by the first imaging mast, the operations further comprising:
verifying a presence of the object by detecting the object in the scanning device using the second imaging mast based at least in part on the pulse rate of the electromagnetic waves emitted by the second imaging mast.

7. The system of claim 1, further comprising a pair of light curtain devices, which together selectively generate a light curtain in an opening of the scanning device.

8. The system of claim 7, the operations further comprising verifying a presence of the object by detecting the object interrupting the light curtain.

9. The system of claim 8, wherein the pair of light curtain devices comprises a transmitter light curtain device and a receiver transmitter light.

10. The system of claim 8, wherein each of the pair of light curtain devices is an opto-electronic device.

11. The system of claim 8, wherein the opening of the body scanner is an entrance to the body scanner.

12. The system of claim 8, wherein the opening of the body scanner is an exit of the body scanner.

13. The system of claim 8, wherein the pair of light curtain devices is a first pair of light curtain devices, the light curtain is a first light curtain, and the opening of body scanner is a first opening of the body scanner, the system further comprising a second pair of light curtain devices, which together selectively generate a second light curtain in a second opening of the body scanner.

14. The system of claim 1, further comprising:
a linear transceiver array,
wherein the operations further comprise detecting the object entering or egressing the body scanner system using at least one of the first imaging mast, the second imaging mast, or the linear transceiver array.

15. The system of claim 14, wherein the linear transceiver array uses a synthetic-aperture radar (SAR).

16. A computer-implemented method for detecting an object entering or egressing a body scanner system, the method comprising:
transmitting and receiving electromagnetic waves by a first imaging mast or a second imaging mast of the body scanner system while stationary;
detecting the object entering or egressing the body scanner system based on the electromagnetic waves received by the first imaging mast or the second imaging mast; and
responsive to detecting the object entering or egressing the body scanner system, implementing a corrective action.

15. The computer-implemented method of claim 14, wherein the body scanner system further comprises a pair of light curtain devices comprising a first transmitter light curtain device and a first receiver transmitter light to generate a light curtain.

16. The computer-implemented method of claim 15, further comprising verifying a presence of the object by detecting the object interrupting the light curtain.

17. The computer-implemented method of claim 15, wherein each of the pair of light curtain devices is an opto-electronic device.

18. The computer-implemented method of claim 14, further comprising determining a direction of movement of the object relative to the body scanner system.

19. The computer-implemented method of claim 14, wherein the detecting is performed using a Doppler effect of the electromagnetic waves emitted by the at least one of the first imaging mast or the second imaging mast.

20. The computer-implemented method of claim 18, wherein the detecting the object is performed using both of the first imaging mast and the second imaging mast based at least in part on a pulse rate of the electromagnetic waves emitted by both of the first imaging mast and the second imaging mast.
